(19) United States
(12) Patent Application Publication
(10) Pub. No.: US 2013/0309388 A1
(43) Pub. Date: Nov. 21, 2013

(54) CARBONATE-RETAINING AGENT FOR CARBONATED DRINK

(71) Applicants: Hiroko Yano, Izumisano-shi (JP); Mizuho Iwano, Izumisano-shi (JP); Hitoshi Furuta, Izumisano-shi (JP)

(72) Inventors: Hiroko Yano, Izumisano-shi (JP); Mizuho Iwano, Izumisano-shi (JP); Hitoshi Furuta, Izumisano-shi (JP)

(73) Assignee: FUJI OIL COMPANY LIMITED, Osaka-shi, Osaka (JP)

(21) Appl. No.: 13/980,955

(22) PCT Filed: Jan. 20, 2012
(86) PCT No.: PCT/JP2012/051183

§ 371 Date: Jul. 22, 2013

(30) Foreign Application Priority Data
Jan. 24, 2011 (JP) 2011-012410

(51) Int. Cl. A23L 2/42

(52) U.S. Cl. CPC A23L 2/42
USPC 426/590; 426/658

(57) ABSTRACT

[Problem] Provided is a material that is capable of suppressing the loss of carbonation in a carbonated beverage over time to reduce changes in flavor, including mouthfeel, when drinking the beverage.

[Solution] Addition of a water-soluble soybean polysaccharide into a non-alcoholic carbonated beverage suppresses the loss of carbonation over time to retain carbonation in the carbonated beverage for a long period of time, thereby reducing changes in flavor during a period from immediately after opening the container thereof to when drinking the beverage after storage.

### TECHNICAL FIELD

The present invention relates to a carbonation retention agent for a carbonated beverage that is capable of retaining carbonation in a carbonated beverage for a long period of time to reduce changes in flavor, including mouthfeel, when drinking the carbonated beverage.

### BACKGROUND ART

Carbonated beverages are widely consumed as beverages whose refreshing mouthfeel is enjoyed when ingested, and alcoholic beverages such as beer, sweetened beverages such as cola and soda pop, and fruit-juice-containing carbonated beverages, for example, are so widely distributed.

Carbonated beverages can be more deliciously drunk by providing a refreshing feeling unique to sparkling carbonation and also by enhancing taste of the beverages with stimulation from the sparkling carbonation. Such a refreshing feeling and flavor depend on the amount of carbonation contained and, when carbonation in the carbonated beverages decreases, such a refreshing feeling is less likely to be felt and the effect of enhancing the taste of the beverages decreases.

For example, when a carbonated beverage filled in a container such as a can or a PET bottle is poured into a cup to be drunk, a refreshing feeling can be obtained immediately after poring it, but there is a problem in that carbonation will be lost soon and the refreshing feeling will be less likely to be felt, whereby the beverage cannot be drunk deliciously. Furthermore, a carbonated beverage filled in a PET bottle cannot be drunk up at once in many cases and, in such a case, there is a problem in that, the loss of carbonation in the remaining carbonated beverage over time changes quality such as mouthfeel and flavor, whereby the beverage cannot be drunk deliciously as a carbonated one.

Examples of a method for preventing the loss of carbonation over time includes a method in which fine bubbles of carbon dioxide are generated and fed into a liquid for beverage (Patent Literature 1). This method lacks versatility in that a special machine is required and a manufacturing process of the beverage becomes complicated.

In addition, a technique of using pea protein as a substance for improving foam generation and foam stability of a beer-taste sparkling alcoholic beverage is disclosed (Patent Literature 2), but wherein a foaming agent of protein is used at a content of no less than 0.5% in a carbonated beverage, so that there is concern about deteriorating influence on the flavor and a technique for further improving the flavor is desired.

### CITATION LIST

### Patent Literature

[Patent Literature 1] Japanese Patent Application Laid-Open Publication No. 2009-100705
[Patent Literature 2] Japanese Patent Application Laid-Open Publication No. 2005-323585

### SUMMARY OF INVENTION

### Technical Problem

In view of the background described above, an object of the present invention is to provide a material that is capable of suppressing the loss of carbonation in a carbonated beverage over time to reduce changes in flavor, including mouthfeel, when drinking the beverage.

### Solution to Problem

The inventors of the present invention have intensively studied on the above problems, and have found that addition of a water-soluble soybean polysaccharide into a non-alcoholic carbonated beverage suppresses the loss of carbonation over time to retain carbonation in the carbonated beverage for a long period of time, thereby reducing changes in flavor during a period from immediately after opening the container thereof to when drinking the beverage after storage. Thus, the inventors have solved the problems by the present invention. That is, the present invention is:

(1) A carbonation retention agent for a non-alcoholic carbonated beverage, comprising a water-soluble soybean polysaccharide.
(2) A method for retaining carbonation in a non-alcoholic carbonated beverage, the method comprising adding the carbonation retention agent according to (1).
(3) A method for manufacturing a non-alcoholic carbonated beverage, the method comprising adding the carbonation retention agent according to (1).
(4) Use of a water-soluble soybean polysaccharide as a carbonation retention agent for a non-alcoholic carbonated beverage.

### Advantageous Effects of Invention

A product of the present invention suppresses the loss of carbonation in a non-alcoholic carbonated beverage over time, thereby reducing changes in flavor, including mouthfeel, when drinking the beverage. With the present invention, even when time passes after opening a container of a carbonated beverage, it is possible to drink the carbonated beverage with a refreshing feeling.

### DESCRIPTION OF EMBODIMENTS

Raw Material

A raw material for a water-soluble soybean polysaccharide contained in a carbonation retention agent of the present invention is preferably derived from soybean cotyledon, for which okara (soybean residue) that is a by-product in producing tofu (soybean curd) or soybean protein isolate, for example, can be used. When fat-containing okara is used, flavor deterioration due to oxidation by heating oil contained therein may occur. Thus, it is preferable to use okara obtained from defatted soybean, and it is most preferable to use okara that is produced as a by-product in a step of manufacturing soybean protein isolate.

Method for Manufacturing Water-Soluble Soybean Polysaccharide

The water-soluble soybean polysaccharide can be obtained, for example, by adding water to okara that is produced as a by-product at the step of manufacturing soybean protein isolate, then separating a slurry thermally extracted at a temperature over 100° C. into solid and liquid phases with a centrifuge, and purifying and drying the supernatant.

As a pH value for the heat treatment of the okara, a pH from 3 to 7 inclusive is preferable, and a pH greater than 4 and equal to or less than 6 is more preferable. Flavor or color may deteriorate when the pH is excessively high, and the water-soluble soybean polysaccharide may be excessively degraded into small molecules when the pH is excessively low. In such cases, the effect of the present invention undesirably decreases.

The heating temperature is higher than 100° C., and preferably higher than 100° C. and equal to or lower than 130° C. The extraction rate of the water-soluble soybean polysaccharide may decrease when the temperature is excessively low, and the water-soluble soybean polysaccharide may be excessively degraded into small molecules when the temperature is excessively high. In such cases, the effect of the present invention undesirably decreases.

Sterilization

It is desirable that the water-soluble soybean polysaccharide be sterilized at the time of manufacture as necessary. Any type of method can be used for the sterilization, and examples of the method include high-temperature sterilization such as UHT sterilization, retort sterilization, electromagnetic sterilization, high-temperature vacuum sterilization, ozone sterilization, electrolyzed water sterilization, and indirect heating sterilization.

Drying

It is desirable that the water-soluble soybean polysaccharide be dried as necessary. Known methods can be used for this drying, and examples thereof include a freeze-drying method, a spray drying method, a shelf drying method, a drum drying method, a belt drying method, a fluidized-bed drying method, and a microwave drying method. The water content after the drying is desired to be 10% or less in terms of preservability.

Carbonation Retention Agent

The carbonation retention agent for a non-alcoholic carbonated beverage in the present invention means one that is capable of suppressing the loss of carbonation in the carbonated beverage over time after opening the container thereof to reduce changes in flavor, including mouthfeel, when drinking the beverage.

In the present invention, the effect of suppressing the loss of carbonation in the non-alcoholic carbonated beverage over time after opening the container thereof is evaluated in terms of a sparkling feeling and a sparkling persistent feeling. The sparkling feeling herein is an index for evaluating a feeling of stimulation caused by sparkling carbonation immediately after drinking a carbonated beverage, and the sparkling persistent feeling is an index for evaluating persistence of a feeling of stimulation by sparkling carbonation remaining on the tongue after drinking the carbonated beverage.

In other words, a carbonated beverage that provides a more intense feeling of stimulation by sparkling carbonation and longer persistence of the feeling of stimulation by sparkling carbonation is considered to have a better sparkling feeling and better sparkling persistent feeling, and thus is a more preferable carbonated beverage.

Non-Alcoholic Carbonated Beverage

Examples of the non-alcoholic carbonated beverage in the present invention include soft drinks containing carbonation, such as carbonated water, a sweetened carbonated beverage, a fruit-juice-containing carbonated beverage, and a non-alcoholic non-fermented beer-taste carbonated beverage, in which carbonation is made to be contained at any stage in the beverage manufacturing process. The non-alcoholic carbonated beverage is preferred to be a carbonated beverage in which alcohol is not substantially contained, into which ethanol is not added, and also the manufacturing process of which does not include an ethanol fermenting step. Examples of the sweetened carbonated beverage include soda pop, lemon soda, and cola.

Method for Manufacturing Non-Alcoholic Carbonated Beverage

As a method for obtaining the non-alcoholic carbonated beverage into which the carbonation retention agent of the present invention is made to be contained, commonly used methods can be used. For example, for a carbonated beverage such as soda pop, lemon soda, or cola, when preparing syrup by dissolving sweetening agents such as sugar, glucose, and isomerized sugar in water, the carbonation retention agent is dissolved in water together with these sweetening agents, whereby the carbonation retention agent is made to be contained in the syrup. Fruit juice, organic acid such as citric acid, or flavor, for example, is made to be contained in the syrup solution as necessary. A carbonated-water-based sparkling drink is produced in a manner such that a container is charged with the solution thus obtained, filled with carbonation or water in which carbonation is made to be contained by pressure, and sealed with a stopper. Alternatively, the carbonated-water-based sparkling drink is produced by a method in which all amount of the solution is mixed with carbonation and then a container is charged with the resultant solution.

In addition, for example, the manufacturing process of the non-fermented beer-taste carbonated beverage employs steps that are implemented in a manufacturing process for an ordinary non-fermented beer-taste carbonated beverage. As an example, the non-alcoholic beer-taste carbonated beverage is prepared by boiling a primary raw material liquid containing the carbonation retention agent of the present invention and a malt extract as raw materials, then adding a hop extraction liquid and flavor therein and heating them again, and adding carbonation through a carbonation step. If needed, a precipitate can be separated and removed by a filtration and a centrifuge, for example, at each stage. Alternatively, carbonated water may be added after preparing the above-described raw material liquid in a highly concentrated state. By using a manufacturing process for ordinary soft drinks to implement these steps, a beer-taste carbonated beverage excellent in flavor can be easily prepared even without a fermentation facility. It is further desirable to remove a precipitate before the carbonation step and a carbonated-water addition step because thereby substances causing sediment or unfavorable taste can be removed. Before the carbonation step or the carbonated-water addition step, sterilization operation can also be performed as necessary.

When the non-alcoholic carbonated beverage prepared by the above-described method is poured into a container such as a cup, the sparkling feeling and the sparkling persistent feeling will be excellent and thus mouthfeel will be good at least for 60 minutes.

Even after a cap of a PET bottle charged with a carbonated beverage is opened once, the sparkling feeling and the sparkling persistent feeling of the carbonated beverage will be excellent and mouthfeel will be good at least for one day.

However, when the carbonation retention agent of the present invention is added into an alcoholic carbonated beverage such as beer, the sparkling feeling and the sparkling persistent feeling are inferior. In this manner, the effect of suppressing the loss of carbonation over time in the present invention is exerted on the non-alcoholic carbonated beverage.

The additive amount of the carbonation retention agent of the present invention in the carbonated beverage is preferably 0.005 to 0.5 wt %, and more preferably 0.01 to 0.1 wt % in solid content. The effect may be insufficient when the additive amount is small, and an excessively large amount may make no difference in the effect and also may adversely affect the flavor.

In the present invention, within a range in which the effect of a product of the present invention is not affected, other emulsifiers or stabilizers can be used as appropriate.

Method for Evaluating Non-Alcoholic Carbonated Beverage

A non-alcoholic carbonated beverage obtained by the present invention is evaluated by clarity and sensory evaluation.

Clarity

A carbonated beverage immediately after being prepared is evaluated by visual observation. The carbonated beverage is judged to be passed if it is not cloudy and is clear, or the carbonated beverage is judged to be failed if it is cloudy.

Sensory Evaluation

After opening a container of a carbonated beverage, the effect of suppressing the loss of carbonation over time is comprehensively evaluated by the sparkling feeling and the sparkling persistent feeling.

The sparkling feeling and the sparkling persistent feeling are evaluated in cases when the carbonated beverage is poured into a cup and when the carbonated beverage is stored in a PET bottle.

Sensory Evaluation when Poured in a Cup

A carbonated beverage is prepared by adding the carbonation retention agent of the present invention, and the sparkling feeling and the sparkling persistent feeling are evaluated on the carbonated beverage immediately after the preparation (0 minute) and on the carbonated beverage that was slowly poured in a cup and stored therein at 20° C. for 60 minutes. Assuming that the sparkling feeling and the sparkling persistent feeling on a carbonated beverage without an additive immediately after preparation (0 minute) each are set to 5 points, the sparkling feeling and the sparkling persistent feeling on each carbonated beverage immediately after preparation (0 minute) and on the carbonated beverage stored for 60 minutes are evaluated by four panelists on a scale of 1 to 5 points, and results thereof are averaged. As the sparkling feeling is more intense and as the sparkling feeling persists longer, the point is higher. Subsequently, the difference between a value for the carbonated beverage stored for 60 minutes and a value for the carbonated beverage immediately after preparation (0 minute) is calculated. The sum of differences calculated on the sparkling feeling and the sparkling persistent feeling each is determined to be a sensory evaluation. More specifically, the sensory rating is calculated by the following formula.

Sensory evaluation (point)=(Average of sparkling feeling 60 minutes after preparation-Average of sparkling feeling immediately after preparation (0 minute))+(Average of sparkling persistent feeling 60 minutes after preparation-Average of sparkling persistent feeling immediately after preparation (0 minute))

If this sensory evaluation point is −3.5 points or higher, the carbonated beverage is considered to be able to maintain the sparkling feeling and the sparkling persistent feeling, and is judged to be passed.

Evaluation when Stored in a PET Bottle

The carbonation retention agent of the present invention is added into a carbonated beverage in a PET bottle, and the sparkling feeling and the sparkling persistent feeling are evaluated on the carbonated beverage immediately after the preparation (0 minute) and on the carbonated beverage stored therein at 20° C. for one day. The evaluation method is the same as that in the case when the carbonated beverage is poured in a cup.

If this sensory evaluation point is −2.0 points or higher, the carbonated beverage is considered to be able to maintain the sparkling feeling and the sparkling persistent feeling, and is judged to be passed.

### EXAMPLES

Examples will be described hereinafter. In the examples, all parts and percentages are based on weight.

Example of Manufacturing Water-Soluble Soybean Polysaccharide

The pH of a slurry in which two part of water was added to one part of okara produced as a by-product at a step of manufacturing soybean protein isolate was adjusted at 5.0 with hydrochloric acid, and the slurry was heated in an autoclave at 120° C. for 1.5 hours. The slurry thus heated was centrifuged (at 5000 G) with a centrifuge, and the supernatant was obtained. After the supernatant was purified, a water-soluble soybean polysaccharide A was obtained by freeze-drying.

### Experimental Examples

### Additive Amount

From 500 grams each of commercially available carbonated water in PET bottles (Product name: Cheerio Carbonated Water, manufactured by Cheerio Corporation), 25 grams each of carbonated water was removed. In place thereof, 25 grams each of 0.02, 0.1, 0.2, 1, 2, 10, and 20% aqueous solutions of the water-soluble soybean polysaccharide A were added, totaling 500 grams, and thus concentrations of the water-soluble soybean polysaccharide A in carbonated beverages were respectively adjusted at 0.001, 0.005, 0.01, 0.05, 0.1, 0.5, and 1.0%. After putting caps thereon, the bottles were slowly turned over three times to make the solutions uniform, and thus carbonated beverages containing the carbonation retention agent of the present invention were obtained.

TABLE 1
Additive Amount of Carbonation Retention Agent and
Evaluation of Carbonated Beverage

| | | Sparkling feeling | | | Sparkling persistent feeling | | | |
|---|---|---|---|---|---|---|---|---|
| Additive | | | One | | | One | | Sensory |
| amount | | | day | | | day | | evaluation |
| (%) | Clarity | 0 min | later | Difference | 0 min | later | Difference | (point) |
| 0.0 | Good | 5.0 | 3.5 | −1.5 | 5.0 | 3.0 | −2.0 | −3.5 |
| 0.001 | Good | 5.0 | 3.0 | −2.0 | 5.0 | 3.8 | −1.2 | −3.2 |
| 0.005 | Good | 4.5 | 3.8 | −0.7 | 5.0 | 3.8 | −1.2 | −1.9 |
| 0.01 | Good | 4.5 | 4.0 | −0.5 | 5.0 | 4.3 | −0.7 | −1.2 |
| 0.05 | Good | 4.5 | 4.0 | −0.5 | 5.0 | 4.5 | −0.5 | −1.0 |
| 0.1 | Good | 4.3 | 3.8 | −0.7 | 5.0 | 4.5 | −0.5 | −1.2 |
| 0.5 | Good | 4.3 | 3.3 | −1.0 | 5.0 | 4.3 | −0.7 | −1.7 |
| 1.0 | Good | 4.3 | 3.3 | −1.0 | 5.0 | 4.3 | −0.7 | −1.7 |

(Clarity) Good: Clear, Poor: Cloudy

As indicated by the results in Table 1, when the additive amount of the carbonation retention agent in the carbonated beverage was 0.005 to 1.0%, excellent results were obtained with the sensory evaluation point of −2.0 points or higher. When the additive amount was 0.001%, the effect as a carbonation retention agent was small. There was no difference in the effect between the additive amounts of 0.5% and 1.0%, and thus addition in the additive amount of 0.5% or larger did not make any difference.

Examples Applied to Carbonated Water

### Example 1

From 500 grams of commercially available carbonated water in a PET bottle (Product name: Cheerio Carbonated Water, manufactured by Cheerio Corporation), 25 grams of carbonated water was removed. In place thereof, 25 grams of 1% aqueous solution of the water-soluble soybean polysaccharide A was added, totaling 500 grams. After putting a cap thereon, the bottle was slowly turned over three times to make the solution uniform, and thus a carbonated beverage containing the carbonation retention agent of the present invention was obtained.

### Comparative Example 1

The same preparation as that in Example 1 was used other than adding 25 grams of water instead of the aqueous solution of the water-soluble soybean polysaccharide.

### Comparative Example 2

The same preparation as that in Example 1 was used other than using xanthan gum (Product name: SAN-ACE, manufactured by San-Ei Gen F.F.I., Inc.) instead of the water-soluble soybean polysaccharide.

### Comparative Example 3

The same preparation as that in Example 1 was used other than using pectin (Product name: SM777, manufactured by San-Ei Gen F.F.I., Inc.) instead of the water-soluble soybean polysaccharide.

### Comparative Example 4

The same preparation as that in Example 1 was used other than using indigestible dextrin (Product name: Fibersol-2H, manufactured by Matsutani Chemical Industry Co., Ltd.) instead of the water-soluble soybean polysaccharide.

### Comparative Example 5

The same preparation as that in Example 1 was used other than using polydextrose (Product name: Litess Ultra, manufactured by Danisco Japan Ltd.) instead of the water-soluble soybean polysaccharide.

### Comparative Example 6

The same preparation as that in Example 1 was used other than using octenyl succinic acid starch (Product name: Emulstar A1, manufactured by Matsutani Chemical Industry Co., Ltd.) instead of the water-soluble soybean polysaccharide.

Result

TABLE 2
Evaluation of Carbonated Water When Poured in a Cup

| | | Sparkling feeling | | | Sparkling persistent feeling | | | Sensory |
|---|---|---|---|---|---|---|---|---|
| | | | 60 min | | | 60 min | | evaluation |
| | Clarity | 0 min | later | Difference | 0 min | later | Difference | (point) |
| Example 1 | Good | 4.5 | 2.5 | −2.0 | 5.0 | 4.0 | −1.0 | −3.0 |
| Comparative | Good | 5.0 | 1.8 | −3.2 | 5.0 | 1.0 | −4.0 | −7.2 |
| Example 1 | | | | | | | | |
| Comparative | Poor | 4.5 | 2.3 | −2.2 | 4.5 | 2.0 | −2.5 | −4.7 |
| Example 2 | | | | | | | | |
| Comparative | Good | 4.0 | 2.3 | −1.7 | 4.5 | 1.5 | −3.0 | −4.7 |
| Example 3 | | | | | | | | |
| Comparative | Good | 4.5 | 1.8 | −2.7 | 4.5 | 2.0 | −2.5 | −5.2 |
| Example 4 | | | | | | | | |
| Comparative | Good | 4.5 | 1.8 | −2.7 | 4.5 | 1.5 | −3.0 | −5.7 |
| Example 5 | | | | | | | | |
| Comparative | Good | 4.5 | 2.0 | −2.5 | 5.0 | 2.0 | −3.0 | −5.5 |
| Example 6 | | | | | | | | |

(Clarity) Good: Clear, Poor: Cloudy

As indicated by the results in Table 2, in Example 1 where the water-soluble soybean polysaccharide was added, clarity was good, and the result of the sensory evaluation was −3.0 points, judged to be passed. In contrast, even when nothing was added and also when other polysaccharides were added as in Comparative Examples 1 to 6, the results of the sensory evaluation were inferior. When xanthan gum was added in Comparative Example 2, clarity also was not good.

By adding the water-soluble soybean polysaccharide, a carbonated beverage could be prepared that could maintain the sparkling feeling and the sparkling persistent feeling of the carbonated beverage after being poured into a cup and suppress the loss of carbonation over time to provide a refreshing feeling.

Examples Applied to Carbonated Water

### Example 2

From 500 grams of commercially available carbonated water in a PET bottle (Product name: Cheerio Carbonated Water, manufactured by Cheerio Corporation), 25 grams of carbonated water was removed. In place thereof, 25 grams of 1% aqueous solution of the water-soluble soybean polysaccharide A was added, totaling 500 grams. After putting a cap thereon, the bottle was slowly turned over three times to make the solution uniform, and thus a carbonated beverage containing the carbonation retention agent of the present invention was obtained. This carbonated beverage immediately after the preparation and the carbonated beverage stored at 20° C. for one day were evaluated.

### Comparative Example 7

The same preparation as that in Example 2 was used other than adding 25 grams of water instead of the aqueous solution of the water-soluble soybean polysaccharide.

### Comparative Example 8

The same preparation as that in Example 2 was used other than using xanthan gum (Product name: SAN-ACE, manufactured by San-Ei Gen F.F.I., Inc.) instead of the water-soluble soybean polysaccharide.

### Comparative Example 9

The same preparation as that in Example 2 was used other than using pectin (Product name: SM777, manufactured by San-Ei Gen F.F.I., Inc.) instead of the water-soluble soybean polysaccharide.

### Comparative Example 10

The same preparation as that in Example 2 was used other than using indigestible dextrin (Product name: Fibersol-2H, manufactured by Matsutani Chemical Industry Co., Ltd.) instead of the water-soluble soybean polysaccharide.

### Comparative Example 11

The same preparation as that in Example 2 was used other than using polydextrose (Product name: Litess Ultra, manufactured by Danisco Japan Ltd.) instead of the water-soluble soybean polysaccharide.

### Comparative Example 12

The same preparation as that in Example 2 was used other than using octenyl succinic acid starch (Product name: Emulstar A1, manufactured by Matsutani Chemical Industry Co., Ltd.) instead of the water-soluble soybean polysaccharide.

TABLE 3
Evaluation of Bottled Carbonated Water

| | | | | | Sparkling | | | |
|---|---|---|---|---|---|---|---|---|
| | | Sparkling feeling | | | persistent feeling | | | |
| | | | One | | | One | | Sensory |
| | | | day | | | day | | evaluation |
| | Clarity | 0 min | later | Difference | 0 min | later | Difference | (point) |
| Example 2 | Good | 4.5 | 4.0 | −0.5 | 5.0 | 4.0 | −1.0 | −1.5 |
| Comparative | Good | 5.0 | 4.0 | −1.0 | 5.0 | 2.0 | −3.0 | −4.0 |
| Example 7 | | | | | | | | |
| Comparative | Poor | 4.5 | 3.0 | −1.5 | 4.5 | 2.0 | −2.5 | −4.0 |
| Example 8 | | | | | | | | |
| Comparative | Good | 4.0 | 2.0 | −2.0 | 4.5 | 1.0 | −3.5 | −5.5 |
| Example 9 | | | | | | | | |
| Comparative | Good | 4.5 | 3.0 | −1.5 | 4.5 | 3.0 | −1.5 | −3.0 |
| Example 10 | | | | | | | | |
| Comparative | Good | 4.5 | 4.0 | −0.5 | 4.5 | 2.0 | −2.5 | −3.0 |
| Example 11 | | | | | | | | |
| Comparative | Good | 4.5 | 4.0 | −0.5 | 5.0 | 3.0 | −2.0 | −2.5 |
| Example 12 | | | | | | | | |

(Clarity) Good: Clear, Poor: Cloudy

As indicated by the results in Table 3, in Example 2 where the water-soluble soybean polysaccharide was added, clarity was excellent, and the result of the sensory evaluation was −1.5 points, judged to be passed. In contrast, even when nothing was added and also when other polysaccharides were added as in Comparative Examples 7 to 12, the results of the sensory evaluation were inferior.

It has been found that, even after the cap of a PET bottle filled with the carbonated beverage is opened once, the sparkling feeling and the sparkling persistent feeling of the carbonated beverage can be maintained at least for one day. By adding the water-soluble soybean polysaccharide, a carbonated beverage could be prepared that could suppress the loss of carbonation over time for a long period of time to provide a refreshing feeling.

Examples Applied to Non-Fermented Beer-Taste Carbonated Beverage

### Example 3

Compositions given in Table 4 were mixed (referred to as primary mixing), boiled for 15 minutes, then secondarily mixed in a composition given in Table 5, and filtered with a paper filter for clarification. Subsequently, carbonated water was added for addition of carbonation in accordance with Table 6. The hop extraction liquid used herein was one obtained by mixing hop pellets into water at a content of 1 wt %, boiling this mixture for one hour to extract a bittering compound, and then removing an unnecessary fraction by filtration with a paper filter. The amount of malt extract used herein was 3.3 wt % of the final beverage in terms of dry matter.

TABLE 4
Primary Composition

| | | Comparative |
|---|---|---|
| | Example 3 | Example 13 |
| Malt extract (manufactured by Muntons PLC) | 2.0 | 2.0 |
| Water-soluble soybean polysaccharide A | 0.05 | — |
| Syrup MS (manufactured by Showa Shoji Co., | 2.5 | 2.5 |
| Ltd) | | |
| High maltose syrup (MC55, manufactured by | 2.5 | 2.5 |
| Nihon Shokuhin Kako Co., Ltd.) | | |
| Glucose | 0.1 | 0.1 |
| Water | 22.5 | 22.5 |

TABLE 5
Secondary Composition

| | Parts |
|---|---|
| Liquid boiled after primary mixing | 22.5 |
| Hop extraction liquid | 7.0 |
| Polydextrose (Litess Ultra, manufactured by Danisco Japan Ltd.) | 1.0 |
| Malt flavor | 0.2 |

TABLE 6
Tertiary composition

| | Parts |
|---|---|
| Liquid boiled after secondary mixing | 30 |
| Carbonated water | 70 |

TABLE 7
Evaluation of Non-Fermented Beer-Taste Carbonated Beverage

| | | | | | Sparkling persistent | | | |
|---|---|---|---|---|---|---|---|---|
| | | Sparkling feeling | | | feeling | | | Sensory |
| | | | 60 min | | | 60 min | | evaluation |
| | Clarity | 0 min | later | Difference | 0 min | later | Difference | (point) |
| Example 3 | Good | 4.5 | 3.0 | −1.5 | 5.0 | 4.0 | −1.0 | −2.5 |
| Comparative | Poor | 5.0 | 2.0 | −3.0 | 5.0 | 2.0 | −3.0 | −6.0 |
| Example 13 | | | | | | | | |

As indicated by the results in Table 7, in Example 3 where the water-soluble soybean polysaccharide was added, clarity was good, and the result of the sensory evaluation was −2.5 points, judged to be passed. In contrast, when the water-soluble soybean polysaccharide was not added as in Comparative Example 13, the result of the sensory evaluation was inferior.

### Comparative Example 14

### Alcoholic Carbonated Beverage

From 350 grams of commercially available beer in a can (Product name: YEBISU BEER, manufactured by Sapporo Breweries Limited), 65 grams of beer was removed. In place thereof, 15 grams of 1% aqueous solution of the water-soluble soybean polysaccharide A was added, totaling 300 grams. The can was slowly moved to make the solution uniform, and thus an alcoholic carbonated beverage was obtained.

TABLE 8
Evaluation of Alcoholic Carbonated Beverage Poured in a Cup

| | | | | | Sparkling persistent | | | |
|---|---|---|---|---|---|---|---|---|
| | | Sparkling feeling | | | feeling | | | Sensory |
| | | | 60 min | | | 60 min | | evaluation |
| | Clarity | 0 min | later | Difference | 0 min | later | Difference | (point) |
| Comparative | Good | 5.0 | 2.0 | −3.0 | 5.0 | 2.0 | −3.0 | −6.0 |
| Example 14 | | | | | | | | |

As indicated by the result in Table 8, in Comparative Example 14 where the water-soluble soybean polysaccharide was added to the beer as an alcoholic carbonated beverage, the result of the sensory evaluation was inferior.

### INDUSTRIAL APPLICABILITY

By adding a water-soluble soybean polysaccharide, it is possible to suppress the loss of carbonation in a non-alcoholic carbonated beverage over time, and this effect can reduce changes in flavor, including mouthfeel, when drinking the beverage. With the present invention, even when time passes after opening a container of a carbonated beverage, it is possible to drink the carbonated beverage with a refreshing feeling.

1. A carbonation retention agent for a non-alcoholic carbonated beverage, comprising a water-soluble soybean polysaccharide.

2. A method for retaining carbonation in a non-alcoholic carbonated beverage, the method comprising adding the carbonation retention agent for a non-alcoholic carbonated beverage, comprising a water-soluble soybean polysaccharide.

3. A method for manufacturing a non-alcoholic carbonated beverage, the method comprising adding the carbonation retention agent for a non-alcoholic carbonated beverage, comprising a water-soluble soybean polysaccharide.

4. Use of a water-soluble soybean polysaccharide as a carbonation retention agent for a non-alcoholic carbonated beverage.
